(19) United States
(12) Patent Application Publication
(10) Pub. No.: US 2021/0094103 A1
(43) Pub. Date: Apr. 1, 2021

(54) POWER TOOL STRUCTURE

(71) Applicant: Basso Industry Corp., Taichung (TW)

(72) Inventors: San-Yih SU, Taichung (TW); Tian-Chi LAI, Taichung (TW); Yu-Da CHEN, Taichung (TW)

(21) Appl. No.: 17/033,911

(22) Filed: Sep. 27, 2020

(30) Foreign Application Priority Data
Oct. 1, 2019 (TW) 108213003

(51) Int. Cl. B23B 31/16; B25F 5/02

(52) U.S. Cl. CPC B23B 31/1605; B25F 5/02

(57) ABSTRACT

A power tool structure including a main body, a socket, a positioning ball, a pressing ring, a locking mechanism and a head is provided. The socket is connected to the main body and includes an arc space and a through hole passing through an annular wall of the socket to communicate with the arc space. The positioning ball is movably received in the through hole. The pressing ring includes a track. The locking mechanism sleeves on the pressing ring and is coupled to the pressing ring. The locking mechanism includes a coupling portion corresponding to the track, and the locking mechanism is forced to rotate so as to switch between a first position and a second position relative to the pressing ring, thereby allowing the locking mechanism to selectively press against the positioning ball. The head is pivotally inserted in the socket and includes a positioning portion.

### RELATED APPLICATIONS

This application claims priority to Taiwan Application Serial Number 108213003, filed Oct. 1, 2019, which is herein incorporated by reference.

### BACKGROUND

### Technical Field

The present disclosure relates to a power tool structure. More particularly, the present disclosure relates to a power tool structure with a swingable head.

### Description of Related Art

The improvement of the technology increases the technique development of tools. Tools adapting electrical power or automatic tools replace the conventional manual tools and are widely used in daily life, which increases the convenience in the human world. Moreover, the pneumatic or electric handheld power tools are popular owing to the portability and the usage convenience thereof.

In order to solve the disadvantage that the angle between the head and the main body of the power tool is not adjustable, a power tool with a swingable head is developed. The power tool includes a ball-shaped socket configured for the head to be inserted therein, and a locking mechanism is used to press the positioning ball to secure the ball-shaped socket and the head, thereby allowing the angle of the head to be changed.

However, the conventional locking mechanism has disadvantages of complex structures, uneasy installations and unintuitive operations; consequently, improvement thereof is required as mentioned in U.S. Pat. No. 5,020,281. In addition, after long-term operation, abrasions of the locking mechanism occur, which results in decrease of the power tool reliability, and improvement thereof is required as mentioned in Taiwan patent No. M551964.

Based on the aforementioned problems, how to effectively improve the power tool structure to increase the convenience and the reliability thereof becomes a pursuit target for practitioners.

### SUMMARY

According to one aspect of the present disclosure, a power tool structure is provided. The power tool structure includes a main body, a socket, at least one positioning ball, a pressing ring, a locking mechanism and a head. The main body has an axial direction. The socket is connected to one end of the main body and includes an arc space and at least one through hole passing through an annular wall of the socket to communicate with the arc space. The at least one positioning ball is movably received in the at least one through hole. The pressing ring is disposed at the end of the main body and includes a track. The locking mechanism sleeves on an outside of the pressing ring and is coupled to the pressing ring. The locking mechanism includes a coupling portion corresponding to the track, and the locking mechanism is forced to rotate so as to switch between a first position and a second position along the axial direction relative to the pressing ring, thereby allowing the locking mechanism to selectively press against the at least one positioning ball. The head is pivotally inserted in the socket and includes at least one positioning portion. When the locking mechanism is in the first position, swinging of the head relative to the socket is allowed. The at least one through hole corresponds to the at least one positioning portion, and the at least one positioning ball is allowed to contact with the at least one positioning portion. When the locking mechanism is in the second position to force the at least one positioning ball to be restricted by the at least one positioning portion, a relative position between the head and the socket is fixed.

### BRIEF DESCRIPTION OF THE DRAWINGS

The disclosure can be more fully understood by reading the following detailed description of the embodiments, with reference made to the accompanying drawings as follows:

FIG. 1 shows a three-dimensional schematic view of a power tool structure according to one embodiment of the present disclosure.

FIG. 2 shows an exploded view of the power tool structure of FIG. 1.

FIG. 3 shows one cross-sectional view of the power tool structure of FIG. 1.

FIG. 4 shows one partial cross-sectional view of the power tool structure of FIG. 1.

FIG. 5 shows another cross-sectional view of the power tool structure of FIG. 1.

FIG. 6 shows another partial cross-sectional view of the power tool structure of FIG. 1.

FIG. 7 shows a cross-sectional view of a power tool structure according to another embodiment of the present disclosure.

FIG. 8 shows a cross-sectional view of a power tool structure according to yet another embodiment of the present disclosure.

FIG. 9 shows a cross-sectional view of a power tool structure according to still yet another embodiment of the present disclosure.

### DETAILED DESCRIPTION

It will be understood that when an element (or mechanism or module) is referred to as being “disposed on”, “connected to” or “coupled to” another element, it can be directly disposed on, connected or coupled to the other elements, or it can be indirectly disposed on, connected or coupled to the other elements, that is, intervening elements may be present. In contrast, when an element is referred to as being “directly disposed on”, “directly connected to” or “directly coupled to” another element, there is no intervening element present.

In addition, the terms first, second, third, etc. are used herein to describe various elements or components, these elements or components should not be limited by these terms. Consequently, a first element or component discussed below could be termed a second element or component.

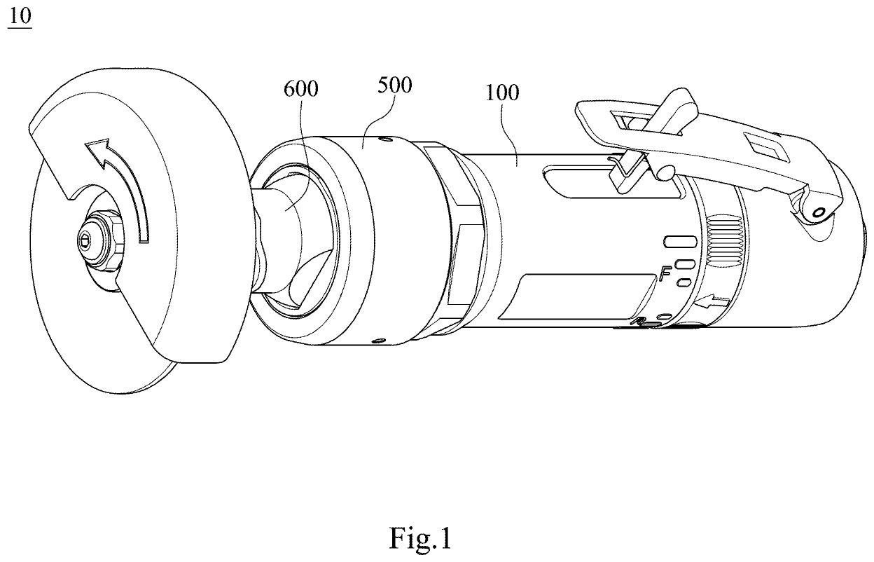

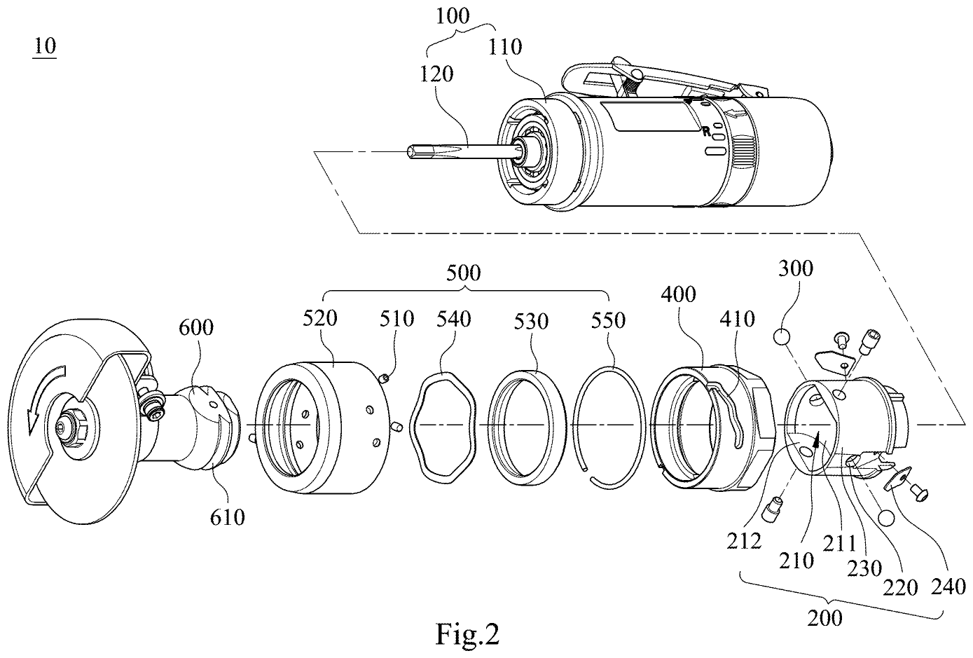

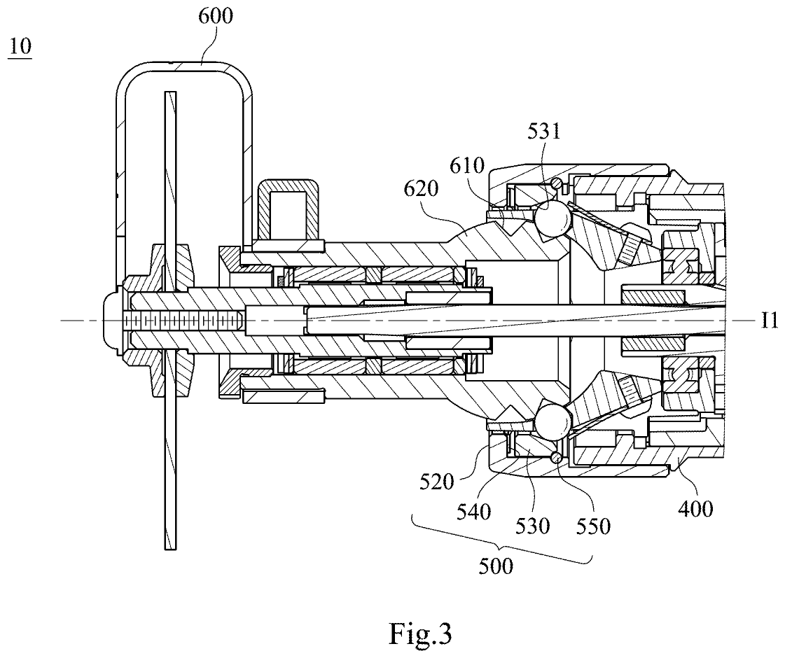

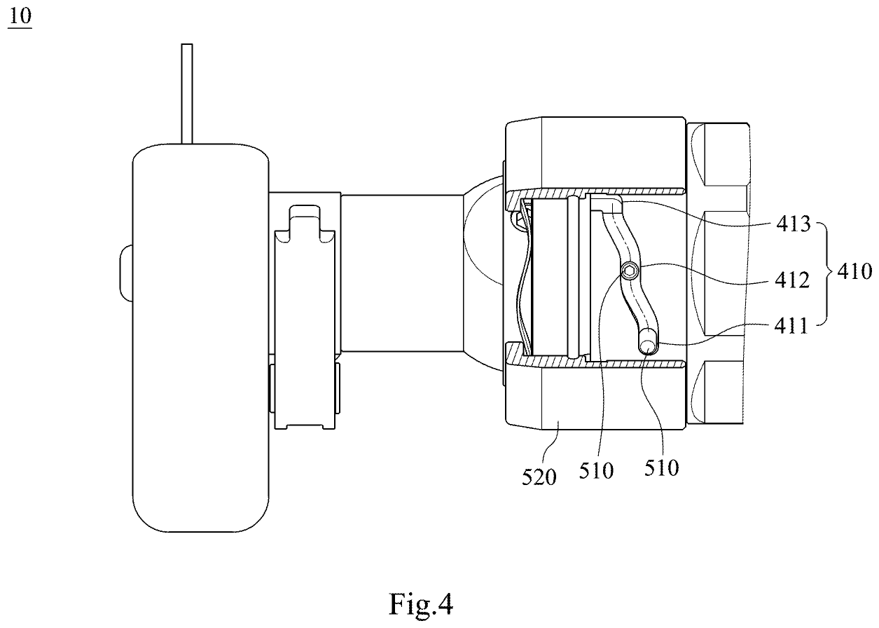

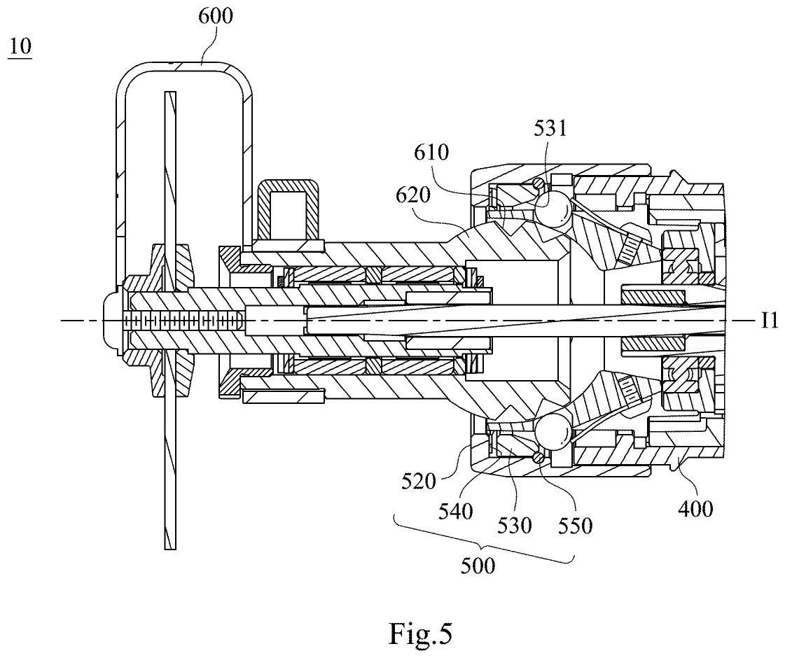

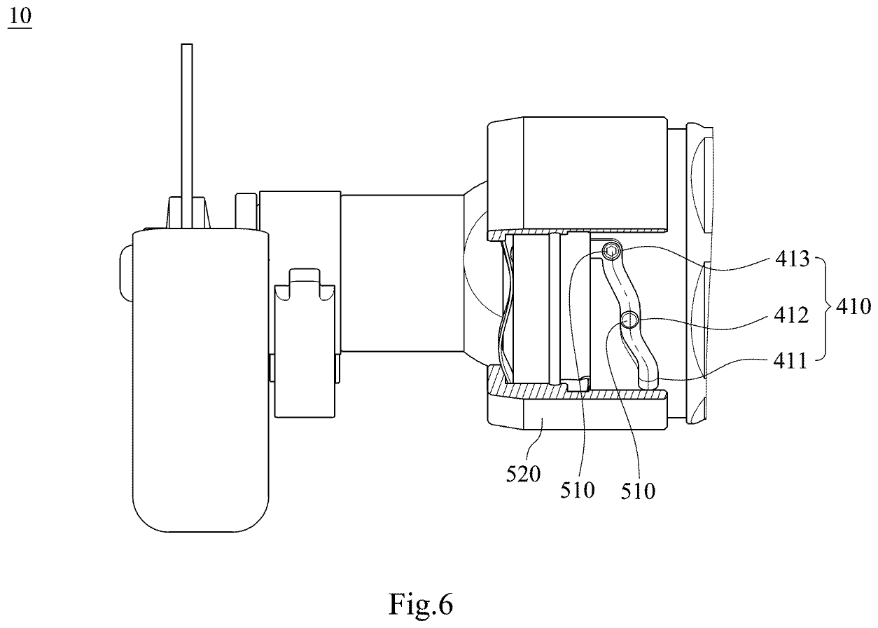

FIG. 1 shows a three-dimensional schematic view of a power tool structure 10 according to one embodiment of the present disclosure. FIG. 2 shows an exploded view of the power tool structure 10 of FIG. 1. FIG. 3 shows one cross-sectional view of the power tool structure 10 of FIG. 1. FIG. 4 shows one partial cross-sectional view of the power tool structure 10 of FIG. 1. FIG. 5 shows another cross-sectional view of the power tool structure 10 of FIG. 1. FIG. 6 shows another partial cross-sectional view of the power tool structure 10 of FIG. 1. As shown in FIGS. 1 to 6, the power tool structure 10 includes a main body 100, a socket 200, at least one positioning ball 300, a pressing ring 400, a locking mechanism 500 and a head 600.

The main body 100 has an axial direction 11. The socket 200 is connected to one end 110 of the main body 100 and includes an arc space 210 and at least one through hole 220 passing through an annular wall 230 of the socket 200 to communicate with the arc space 210. The at least one positioning ball 300 can be movably received in the at least one through hole 220. The pressing ring 400 is disposed at the end 110 and includes a track 410. The locking mechanism 500 sleeves on an outside of the pressing ring 400 and is coupled to the pressing ring 400. The locking mechanism 500 includes a coupling portion 510 corresponding to the track 410, and the locking mechanism 500 is forced to rotate so as to switch between a first position and a second position along the axial direction 11 relative to the pressing ring 400, thereby allowing the locking mechanism 500 to selectively press against the at least one positioning ball 300. The head 600 is pivotally inserted in the socket 200 and includes at least one positioning portion 610. When the locking mechanism 500 is in the first position, swinging of the head 600 relative to the socket 200 is allowed. The at least one through hole 220 corresponds to the at least one positioning portion 610. The at least one positioning ball 300 is allowed to contact with the at least one positioning portion 610 (the head 600 shown in the figures is straight). When the locking mechanism 500 is in the second position to force the at least one positioning ball 300 to be restricted by the predetermined positioning portion 610, a relative position between the head 600 and the socket 200 is fixed.

Therefore, because the locking mechanism 500 can be moved along the track 410 of the pressing ring 400 to selectively press against the positioning ball 300 for achieving a locking function or an unlocking function, the using convenience of the power tool structure 10 can be improved. The power tool structure 10 will be described in detail hereafter.

The main body 100 has a circular tube structure and includes a transmission shaft 120 protruding from the end 110. The transmission shaft 120 can be driven to rotate. The structure of the main body 100 is conventional and not a key feature of the present disclosure; hence, the detail thereof will not be mentioned.

The thickness of the annular wall 230 of the socket 200 is uneven such that the arc space 210 can be formed therein. The annular wall 230 of the socket 200 can include an inner curve surface 211 and two inner flat surfaces 212. The inner curve surface 211 is connected between the two inner flat surfaces 212 to form the arc space 210. In the embodiment of FIGS. 1 to 6, a number of the at least one through hole 220 is two, and the two through holes 220 are located at the inner curve surface 211 symmetrically. However, in the other embodiment, a number of the through hole is more than or equal to one, and the present disclosure is not limited thereto.

As the socket 200 is disposed at the end 110 of the main body 100, the transmission shaft 120 will protrude into the arc space 210. The head 600 can be inserted into the arc space 210 to be connected to the transmission shaft 120, and the socket 200 can further include two fastening holes (not labeled) located at the two inner flat surfaces 212, respectively, for the head 600 to be fastened therewith.

Moreover, the socket 200 can further include a flexible board 240 disposed on the annular wall 230 of the socket 200 for pressing the positioning ball 300. Since the flexible board 240 can preliminary press the positioning ball 300, the positioning ball 300 can be positioned temporarily via the configuration of the flexible board 240 when the locking mechanism 500 does not press against the positioning ball 300, thereby avoiding vibration between the head 600 and the socket 200 which is not secured with the head 600 by the locking mechanism 500.

The head 600 can include a head portion 620. The positioning portion 610 is located at the head portion 620 and has a V-shaped groove structure. A number of the positioning portions 610 is four, two of the position portions 610 are located at one side of the head portion 620 with an interval between each other, and the other two of the positioning portions 610 are located at the other side of the head portion 620 with an interval between each other. When the head 600 is swung relative to the socket 200, the positioning ball 300 can be aligned to one of the two positioning portions 610.

The track 410 can be located at an outer wall (not labeled) of the pressing ring 400 and has a concave-groove structure. The coupling portion 510 can have a lever structure configured to protrude into the track 410. In the embodiment of FIGS. 1 to 6, each distance between each point of the track 410 and the edge of the pressing ring 400 along the axial direction 11 is different from one another. Hence, when the locking mechanism 500 is rotated by a user, the coupling portion 510 can move along the track 410, and the locking mechanism 500 is allowed to move along the axial direction 11 while rotating relative to the pressing ring 400. Moreover, the track 410 can include a first smooth segment 411, a second smooth segment 412 and a third smooth segment 413. A slope segment (not labeled) is connected between the first smooth segment 411 and the second smooth segment 412, and another slope segment (not labeled) is connected between the second smooth segment 412 and the third smooth segment 413. The first smooth segment 411, the second smooth segment 412 and the third smooth segment 413 are parallel to the edge of the pressing ring 400. When the coupling portion 510 is moved to one of the first smooth segment 411, the second smooth segment 412 and the third smooth segment 413, the coupling portion 510 can be positioned.

The locking mechanism 500 can further include a locking barrel 520 and a compressing ring 530. The locking barrel 520 sleeves on the pressing ring 400. The coupling portion 510 is disposed at the locking barrel 520 and protrudes from an inner wall (not labeled) of the locking barrel 520. The compressing ring 530 is disposed within the locking barrel 520. A rotation of the locking barrel 520 drives the coupling portion 510 to move in the track 410, and the locking barrel 520 is allowed to move the compressing ring 530 along the axial direction 11, thereby allowing the compressing ring 530 to push against the positioning ball 300.

During manufacturing, a screw, a solid pin, a spring pin or a parallel pin with lever structure can be used as the coupling portion 510. The locking barrel 520 can include one clearance hole (not labeled). The coupling portion 510 can be positioned in the clearance hole and protrude from the inner wall of the locking barrel 520. Hence, as the locking barrel 520 sleeves on the pressing ring 400, the coupling portion 510 can protrude into the track 410. In order to increase the stability in rotation and linear movement, a number of the tracks 410 can be two and the two tracks 410 are arranged symmetrically. Moreover, two coupling portions 510 are adapted to correspond to one track 410 to increase the structural strength.

The compressing ring 530 can include an abutting surface 531 facing towards the positioning ball 300, and the compressing ring 530 is linked up with the locking barrel 520. When the locking mechanism 500 is switched from the first position to the second position, the abutting surface 531 will abut against the positioning ball 300.

Furthermore, the locking mechanism 500 can further include an elastic member 540 located between an end surface (not labeled) of the locking barrel 520 and the compressing ring 530. Therefore, through the elasticity of the elastic member 540, the compressing ring 530 is elastically pushed against the positioning ball 300, thereby achieving an anti-loosening effect. In addition, even if the compressing ring 530 is worn and the thickness is decreased, the elasticity of the elastic member 540 can compensate the decreased thickness, which can increase the reliability of the power tool structure 10. In the embodiment of FIGS. 1 to 6, the elastic member 540 can have a wave-spring structure, but the present disclosure is not limited thereto.

The locking mechanism 500 can further include a C-shaped ring 550 disposed at the inner wall of the locking barrel 520 to restrict the compressing ring 530.

During operation, as shown in FIG. 4, the locking mechanism 500 is restricted in the second position, and the two coupling portions 510 are restricted in the first smooth segment 411 and the second smooth segment 412, respectively. As shown in FIG. 3, the compressing ring 530 presses against the positioning ball 300 to allow the positioning ball 300 to be restricted in the positioning portion 610; meanwhile, the head 600 is also be restricted and unable to rotate relative to the socket 200.

When the user would like to change the angle of the head 600, the locking mechanism 500 can be rotated to switch to the first position. As shown in FIG. 6, after the two coupling portions 510 moved along the track 410, the two coupling portions 510 can be restricted in the second smooth segment 412 and the third smooth segment 413 of the track 410, respectively. Subsequently, as shown in FIG. 5, the compressing ring 530 is moved by the locking barrel 520 far from away the positioning ball 300, and the positioning ball 300 is temporally pressed by the flexible board 240; as a result, the user can rotate the head 600 to change the angle and the positioning ball 300 is allowed to contact with the different positioning portion 610. As the head 600 is rotated to the predetermined angle, the locking mechanism 500 can be operated again and go back to the locking status shown in FIGS. 3 and 4. Please be noted that the locking barrel 520 shown in FIG. 6 is partially cut to show the position relationship between the track 410 and the coupling portion 510.

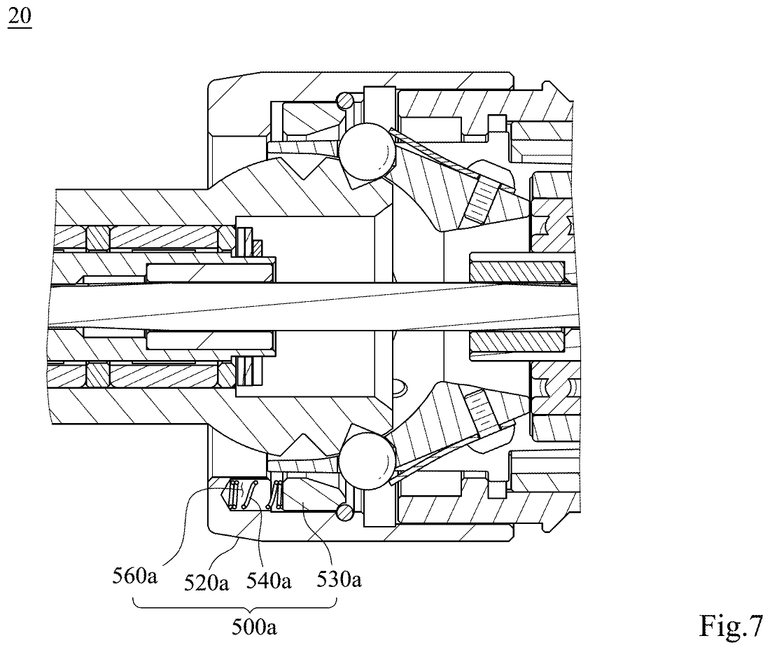

FIG. 7 shows a cross-sectional view of a power tool structure 20 according to another embodiment of the present disclosure. The power tool structure 20 is similar to the power tool structure 10 of FIGS. 1 to 6, and only the differences are mentioned hereafter while the same features are not repeated.

The elastic member 540a of the locking mechanism 500a can have a compression-spring structure, and a number of the elastic member 540a can be more than one. A groove 560a can be disposed at the end surface of the locking barrel 520a to receive the elastic member 540a such that the elastic member 540a can be abutted against the end surface and the compressing ring 530a.

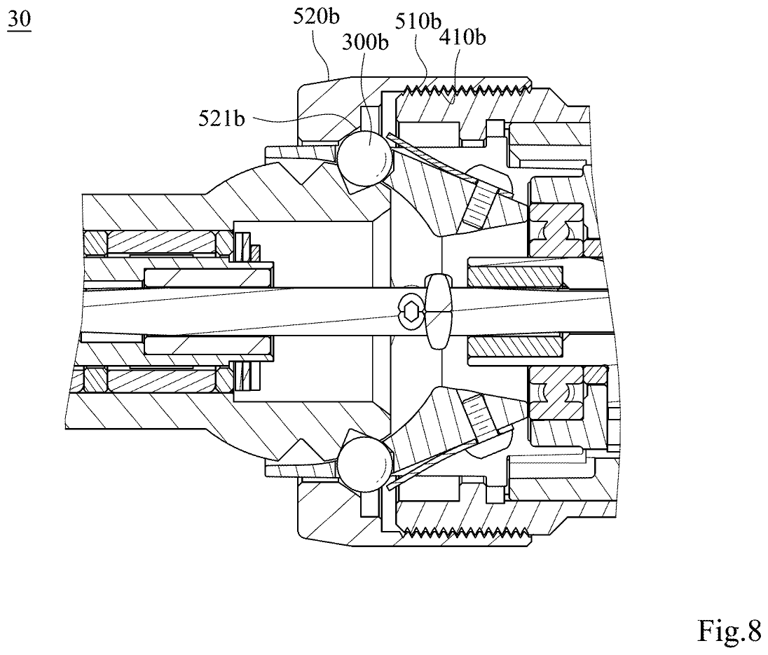

FIG. 8 shows a cross-sectional view of a power tool structure 30 according to yet another embodiment of the present disclosure. The locking mechanism (not labeled) can be composed of a locking barrel 520b, and the coupling portion 510b is located at an inner wall of the locking barrel 520b. A rotation of the locking barrel 520b drives the coupling portion 510b to move along the track 410b, thereby allowing the locking barrel 520b to move along the axial direction such that an inclined end surface 521b of the locking barrel 520b is abutted against the positioning ball 300b. The track 410b can have a female-threaded structure, and the coupling portion 510b can have a male-threaded structure; consequently, as the locking barrel 520b is rotated, the locking barrel 520b can also be moved along the axial direction simultaneously to allow the inclined end surface 521b to selectively press the positioning ball 300b, thereby achieving switch between the lock function and the unlock function.

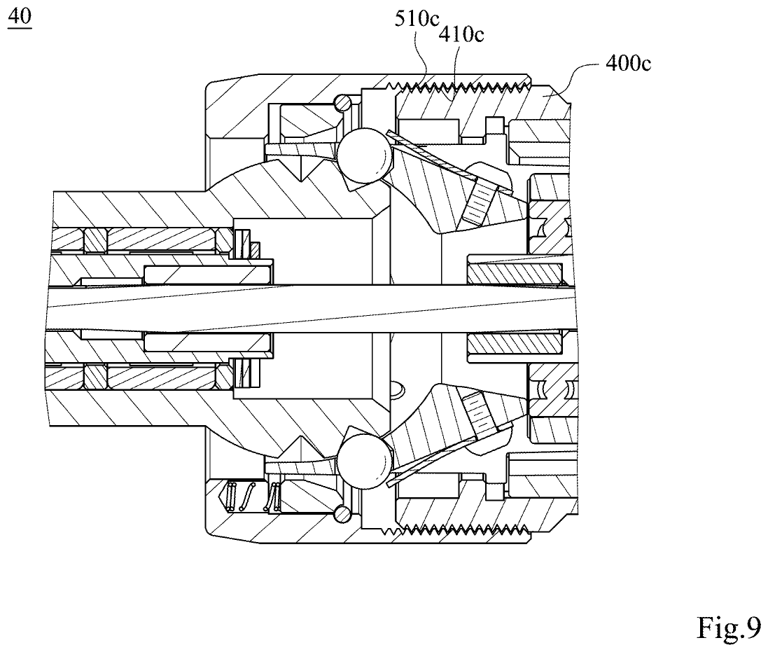

FIG. 9 shows a cross-sectional view of a power tool structure 40 according to still yet another embodiment of the present disclosure. The power tool structure 40 is similar to the power tool structure 20 of FIG. 7, but the track 410c can be located at an outer wall of the pressing ring 400c and have a female-threaded structure. The coupling portion 510c can have a male-threaded structure. The same feature will not be repeated.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure covers modifications and variations of this disclosure provided they fall within the scope of the following claims.

What is claimed is:

1. A power tool structure, comprising:
a main body having an axial direction;
a socket connected to one end of the main body and comprising:
an arc space; and
at least one through hole passing through an annular wall of the socket to communicate with the arc space;
at least one positioning ball movably received in the at least one through hole;
a pressing ring disposed at the end of the main body and comprising a track;
a locking mechanism sleeving on an outside of the pressing ring and coupled to the pressing ring, the locking mechanism comprising a coupling portion corresponding to the track, the locking mechanism being forced to rotate so as to switch between a first position and a second position along the axial direction relative to the pressing ring, thereby allowing the locking mechanism to selectively press against the at least one positioning ball; and
a head pivotally inserted in the socket and comprising at least one positioning portion;
wherein when the locking mechanism is in the first position, swinging of the head relative to the socket is allowed, the at least one through hole corresponds to the at least one positioning portion, and the at least one positioning ball is allowed to contact with the at least one positioning portion; and
when the locking mechanism is in the second position to force the at least one positioning ball to be restricted by the at least one positioning portion, a relative position between the head and the socket is fixed.

2. The power tool structure of claim 1, wherein the locking mechanism further comprises:
a locking barrel sleeving on the pressing ring, wherein the coupling portion is disposed at the locking barrel and protrudes from an inner wall of the locking barrel; and
a compressing ring disposed within the locking barrel;
wherein a rotation of the locking barrel drives the coupling portion to move in the track, and the locking barrel is allowed to move the compressing ring along the axial direction, thereby allowing the compressing ring to push against the at least one positioning ball.

3. The power tool structure of claim 2, wherein the locking mechanism further comprises:
an elastic member located between an end surface of the locking barrel and the compressing ring.

4. The power tool structure of claim 3, wherein the elastic member has a wave-spring structure.

5. The power tool structure of claim 3, wherein the elastic member has a compression-spring structure.

6. The power tool structure of claim 2, wherein, the track is located at an outer wall of the pressing ring and has a curved-groove structure, and the coupling portion has a lever structure.

7. The power tool structure of claim 2, wherein the locking mechanism further comprises:
a C-shaped ring disposed at the inner wall of the locking barrel to restrict the compressing ring.

8. The power tool structure of claim 2, wherein the track is located at an outer wall of the pressing ring and has a female-threaded structure, and the coupling portion has a male-threaded structure.

9. The power tool structure of claim 8, wherein the locking mechanism is composed of a locking barrel, the coupling portion is located at an inner wall of the locking barrel, and a rotation of the locking barrel drives the coupling portion to move along the track, thereby allowing the locking barrel to move along the axial direction such that an inclined end surface of the locking barrel is abutted against the at least one positioning ball.

10. The power tool structure of claim 1, wherein the socket further comprises:
a flexible board disposed at the annular wall of the socket to press against the at least one positioning ball.
